(19) United States
(12) Patent Application Publication
(10) Pub. No.: US 2019/0161136 A1
(43) Pub. Date: May 30, 2019

(54) Passenger Safety Handle Bar

(71) Applicant: Craig D. Beltrand, Frisco, TX (US)

(72) Inventor: Craig D. Beltrand, Frisco, TX (US)

(21) Appl. No.: 16/199,437

(22) Filed: Nov. 26, 2018

Related U.S. Application Data
(60) Provisional application No. 62/590,387, filed on Nov. 24, 2017.

(51) Int. Cl. B62K 21/12; B62J 27/00

(52) U.S. Cl. CPC B62K 21/125; B62J 27/00

(57) ABSTRACT

A safety apparatus to be used in vehicles, especially for front passenger safety and control, is disclosed. The safety apparatus described comprises safety handlebar/grip or handlebars/grips placed near or behind the vehicle's handlebar. The handlebars are provided for tight holding of vehicle by the passengers in various adverse conditions. The handlebars/grips ends are curved slightly back towards the passenger to provide a reasonable distance between the handgrips of the vehicle's handlebar and the front safety handlebars or grip locations. Further, the safety handlebar(s) are lesser in width than the vehicle's handlebar to allow the driver to easily reach and manipulate the vehicle controls without interference from the front seated passenger.

### BACKGROUND OF THE INVENTION

### A. Technical Field

The invention generally relates to a safety apparatus. More specifically, the invention relates to a safety apparatus incorporated in vehicles for providing safety to the user or passenger, especially front passengers.

### B. Description of Related Art

All-Terrain Vehicle (ATV) or any recreational vehicle is very popular among families, where children ride along with their parents or other adults. Young children are usually regulated to ride in the safe front place of the driver/operator astride the vehicle between the steering bar/handlebar and the driver. This affords the operator suitable control over the child since the child is in an area right in front of the driver. The driver could quickly access at any situation and adjust the child or other passenger position with their hands. However, the driver has to remove their hands from the steering bars/handlebars to adjust the child's position on the running vehicle. By this action, the driver may lose control or lack concentration on driving the vehicle. Further, the driver has to sacrifice some control at times to keep the child/passenger steady in front of them This example is true for other vehicles such as Jet Skis, Bicycles, Snowmobiles and Motorcycles.

Currently, there are no gripping elements for the children or front passengers, in particular, to hold/maintain their stability. As the vehicle is being maneuvered during the ride, the passenger is often forced into a precarious position with regards to their safety. The center section of the handlebar is covered with control cables and wiring, which prevents the passenger from getting a decent grip to safely secure their position. These riding conditions are unsafe and leads to injury or even death if a fall occurs at higher speed.

Therefore, there is a need for a safety apparatus for the vehicles, which provides control and safety for the child or passengers. Further, the safety apparatus is to be provided with predetermined grip enabling the passengers to hold them, even on travel during bad weather conditions.

### SUMMARY OF THE INVENTION

The invention generally relates to a safety apparatus on a vehicle. More specifically, the invention relates to a safety apparatus used in vehicles for the safety of passengers.

In an embodiment, the safety apparatus can be comprised of a safety handlebar or an auxiliary handlebar for attachment to a primary handlebar of a vehicle. The auxiliary handle bar comprises a pair of diverging handlebar grips. In an embodiment, at least one handlebar grip extends from a left side of the primary handlebar, and at least one handlebar grip extends from a right side of the primary handlebar. In one embodiment, at least one handlebar grip at the left side of the primary handlebar is integrally coupled to the at least one handlebar grip at the right side of the primary handlebar to from a single unit. In another embodiment, the pair of diverging handlebar grips is disposed as a separate unit. The auxiliary handlebar is curved in shape and slightly curved back towards the user. Thick welded plates may be interfaced with the handlebar. There is a reasonable distance between the handgrips of the vehicle's primary handlebar and the safety handlebar. The auxiliary handlebar is lesser in width than the vehicle's primary handlebar to allow the driver to easily reach and manipulate the vehicle controls without interference from the front seated passenger.

In an embodiment, the auxiliary handlebar is produced by drilled welded plates that interface with the vehicle's handlebar. In one embodiment, a mounting screw of the vehicle's handlebar is required to be removed. The mounting assembly and handlebars are lifted up to slide the safety handlebar beneath. The mounting screws are re-installed after the handlebar is placed in its position. The safety handlebar is placed just behind and inside of the vehicle's primary handlebar, which allows an easy and secure grip for the front passenger during the ride. In one embodiment, the safety apparatus is disposed at a rear side of the vehicle for use by a passenger at the rear of the vehicle. In another embodiment, the safety apparatus is disposed at a tank cover of the vehicle. In yet another, the safety apparatus is disposed at an engine cover of the vehicle. In yet another embodiment, the safety apparatus is disposed at saddlebags of the vehicle.

Other objects, features and advantages of the invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 illustrates a safety apparatus for front passenger in vehicles, incorporating the aspects of the invention.

FIG. 2 illustrates a side view of the safety apparatus, incorporating the aspects of the invention.

FIG. 3 illustrates a top view of the safety apparatus, incorporating the aspects of the invention.

FIG. 4 illustrates a sectional view of the safety apparatus, incorporating the aspects of the invention.

FIG. 5 illustrates a handlebar unit comprising a knurled surface and handlebar grips, incorporating the aspects of the invention.

FIG. 6 illustrates a safety apparatus, incorporating the aspects of the invention.

### DETAILED DESCRIPTION OF EMBODIMENTS

A description of embodiments of the invention will now be given with reference to the Figures. It is expected that the invention may be embodied in other specific forms without departing from its spirit or essential characteristics. The described embodiments are to be considered in all respects only as illustrative and not restrictive.

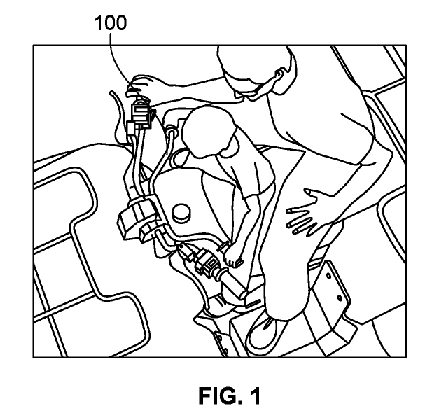

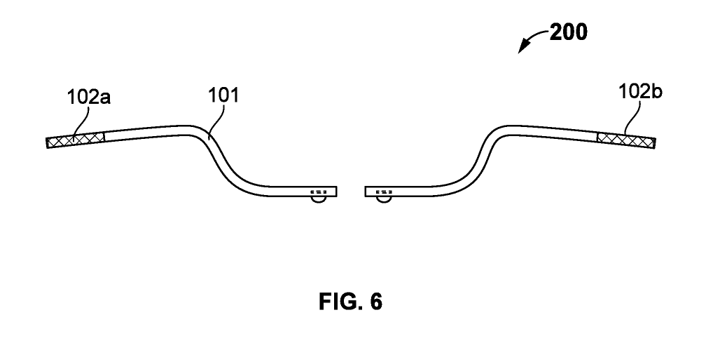

The invention relates to a safety apparatus 100 in vehicles for the safety and control of the front passengers as shown in FIG. 1. In an embodiment, the safety apparatus 100 comprises an axillary handlebar or safety handlebar 101 and a pair of diverging grips or handlebar grip (102a, 102b). In one embodiment, at least one handlebar grip 102a extends from a left side of the primary handlebar, and at least one handlebar grip 102b extends from a right side of the primary handlebar. In one embodiment, at least one handlebar grip 102a at the left side of the primary handlebar is integrally coupled to the at least one handlebar grip 102b at the right side of the primary handlebar to form a single unit. Referring to FIG. 6, the pair of diverging handlebar grips (102a, 102b) of the safety apparatus 200 is disposed as a separate unit. In one embodiment, the integral handlebar grips (102a, 102b) of the safety apparatus 100 could be detached as separate unit.

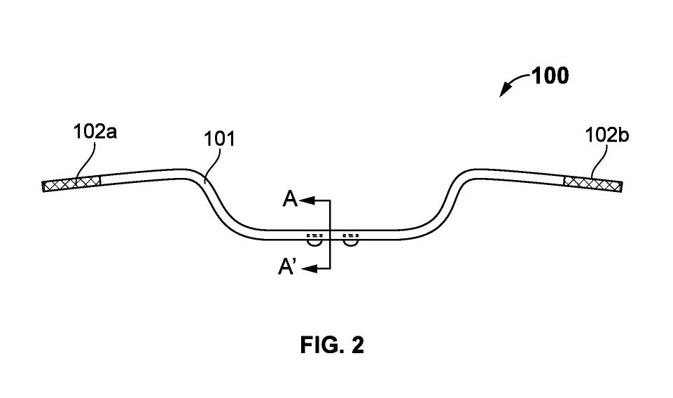

In one embodiment, the safety handlebar 101 is curved in shape and slightly curved back towards the user. Thick welded plates 104 are interfaced with the safety handlebar 101 as shown in FIG. 2. There is a reasonable distance between the handgrips (102a, 102b) of the vehicle's primary handlebar and the safety handlebar 101. In one embodiment, the safety handlebar 101 is lesser in width than the vehicle's primary handlebar to allow the driver to easily reach and manipulate the vehicle controls without interference from the front seated passenger.

In some embodiments, the safety handlebar 101 is fabricated from ⅞″ diameter seamless aluminum tubing, which is extruded using 7050 aluminum alloy. After extrusion, the safety handlebar 101 is cut to length. The safety handlebar 101 is mandrel bent to make smooth curves with no reduction in diameter in the bends. After bending, the safety handlebar 101 is placed in a welding jig with the mounting brackets 104. The safety handlebar or handlebar 101 is robotically welded with the mounting brackets 104. After welding, the handlebar 101 is shot peened all over to reduce stress cracking. The end portions of the handlebar 101 positioning the grips (102a, 102b) are knurled to create a good bonding surface for the grips (102a, 102b). The hand grips (102a, 102b) remains fixed even under rigorous use due to the bonding surface. In an embodiment, handlebars 101 could be produced in almost any vibrant color to match, complement, or contrast with the vehicle color. The handlebars 101 is coated with desired color through anodizing the aluminum handlebar.

In another option, the grip/bars (102a, 102b) can be factory molded into the gas tank or engine cover, rather than being supplied as a handlebar 101. The extruded tubing grip mounts are positioned to slant backwards about the same angle as the vehicle's handlebars while providing safe and comfortable hand position for the front passenger. The handlebar 101 having ⅞″ diameter tubing can accept almost any commercial grip or can be supplied with factory grips. The tubing can also be anodized and dyed before assembly in the tank or engine cover. It would be advantageous to be able to install and/or remove the tank/engine cover mounted grips when not needed or if they are part of a separate tank/engine cover wrap-around attachment such as a tank bag/backpack with passenger grips or saddlebags with passenger grips.

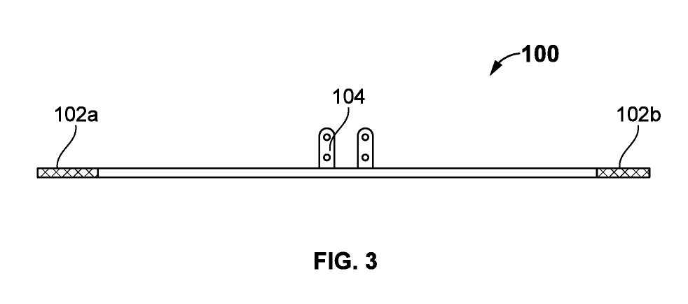

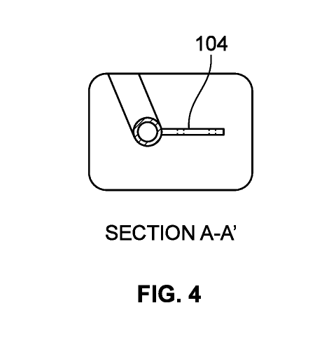

Referring to FIG. 3, a top view of the safety apparatus 100 is illustrated, incorporating the aspects of the invention. In one embodiment, the handlebar 101 is incorporated with the mounting brackets 104, running off at a slight angle. The handlebar 101 is supplied with drilled welded plates 104 that interface with the vehicle's handlebar. In an embodiment, the mounting screw of the vehicle's handlebar is required to be removed. The mounting assembly and handlebars are lifted up to slid the handlebar 101 beneath. The mounting screws are re-installed after the handlebar 101 settled in its position. The safety handlebar 101 is placed just behind the vehicle's handlebar, which allows the front passenger an ease and secure position during the ride. Further, the handlebar 101 is implemented with the grips (102a, 102b). FIG. 4 illustrates a sectional view of the safety apparatus 100. In an embodiment, the mounting brackets 104 are cut from aluminum sheet using a water jet machining center. The shaped mounts are TIG welded to the handlebar tube using a jig to hold them at the proper position.

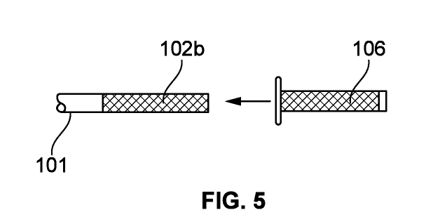

FIG. 5 illustrates the safety apparatus 100 with the handlebar grips (102a, 102b) and handgrip 106, incorporating the aspects of the invention. In an embodiment, the extruded aluminum tube handlebar 101 is shot peened to enhance strength and resist stress cracking during use. The handlebar 101 is a seamless aluminum tube, anodized and dyed to reduce corrosion and provide a decorative color for use on the vehicle. The safety apparatus 100 allows the front riding passenger a place to grip and safely restrain themselves when riding on the vehicle. In another embodiment, the handlebar 101 could be produced without handgrip 106. In another embodiment, the handlebar 101 could be produced with handgrip 106.

In one embodiment, the safety apparatus 100 is disposed at a rear side of the vehicle for use by a passenger at the rear of the vehicle. In another embodiment, the safety apparatus 100 is disposed at a tank cover of the vehicle. In yet another, the safety apparatus 100 is disposed at an engine cover of the vehicle. In yet another embodiment, the safety apparatus 100 is disposed at saddlebags of the vehicle.

The safety apparatus 100 is an innovative safety system, designed to provide a handlebar 101 for the passenger placed in front of the driver. The handlebar 101 moves in conjunction with the vehicle's handlebar but has no controls on it so the driver can operate the vehicle in an unimpeded fashion. The handlebar 101 is made of the same aluminum tube as the vehicle's handlebar. The handlebar 101 has attachment plates 104 welded onto the tube and interface with the support of vehicle's handlebar. The handlebar 101 is shorter in width than the vehicle's handlebar and the driver's hands are outside the ends of the handlebar 101. This arrangement helps the front passenger to maintain a grip, significantly improving their safety during the ride. The safety apparatus 100 fits to almost all watercraft, all-terrain vehicles, snowmobiles, motorcycles, and other vehicles with handlebar controls.

The safety system handlebar or safety apparatus 100 resolves most of the problems by providing an additional handlebar 101, with no controls, just to the rear of the vehicle's handlebar. The handlebar 101 is as strong as the vehicle's handlebar and has grips (102a, 102b) at either end. The ends of the handlebar 101 have non-slip grips (102a, 102b) for passengers to maintain their grip, regardless of the weather conditions or the movement of the vehicle's handlebars during the ride. The narrower width and lower grip position allow the driver of the vehicle to reach the vehicle's handlebars unimpeded so they can maintain normal control of the vehicle. The passenger ensures safety, as they could firmly hold the handlebars 101 just like the driver and can be in synch with the vehicle's movements during the ride.

Accordingly, the advantages of the invention are simple installation and quick disconnect feature versions. The handlebar 101 gives a safe stable grip to the front passenger. The safety apparatus 100 helps to prevent accidents. The safety apparatus 100 allows driver a full control with front passenger on aboard. A less expensive upgrade in vehicle for control and safety and enhancing riding experience. The handlebar 101 can rotate with vehicle steering mechanism, depending upon installation version. The safety apparatus 100 allows small children to ride with adults with enhanced safety measures.

Preferred embodiments of this invention are described herein, including the simplest modes known to the inventors for carrying out the invention. It should be understood that the illustrated embodiments are exemplary only, and should not be taken as limiting the scope of the invention.

The foregoing description comprise illustrative embodiments of the invention. Having thus described exemplary embodiments of the invention, it should be noted by those skilled in the art that the within disclosures are exemplary only, and that various other alternatives, adaptations, and modifications may be made within the scope of the invention. Merely listing or numbering the steps of a method in a certain order does not constitute any limitation on the order of the steps and processes of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the invention is not limited to the specific embodiments illustrated herein.

What is claimed is:

1. A safety apparatus, comprising:
an auxiliary handlebar for attachment to a primary handlebar of a vehicle comprising a pair of diverging handlebar grips,
wherein at least one handlebar grip extends from a left side of the primary handlebar, and
wherein at least one handlebar grip extends from a right side of the primary handlebar.

2. The safety apparatus of claim 1, wherein the auxiliary handlebar is smaller in width than the primary handlebar.

3. The safety apparatus of claim 1, wherein the pair of diverging handlebar grips extends vertically towards a passenger and away from the primary handlebar.

4. The safety apparatus of claim 1, wherein each handlebar grip comprises a mounting bracket for attachment to the primary handlebar.

5. The safety apparatus of the claim 1, wherein an end portion of each handlebar grip comprises knurled surface.

6. The safety apparatus of the claim 5, further comprises a handgrip disposed over the knurled surface of each handlebar grip.

7. The safety apparatus of claim 1, wherein the at least one handlebar grip at the left side of the primary handlebar is integrally coupled to the at least one handlebar grip at the right side of the primary handlebar.

8. The safety apparatus of claim 1, is disposed at a rear side of the vehicle for use by a passenger at the rear of the vehicle.

9. The safety apparatus of claim 1, is disposed at a tank cover of the vehicle.

10. The safety apparatus of claim 1, is disposed at an engine cover of the vehicle.

11. The safety apparatus of claim 1, is disposed at a saddlebag of the vehicle.
